(19) United States
(12) Patent Application Publication
(10) Pub. No.: US 2017/0099345 A1
(43) Pub. Date: Apr. 6, 2017

(54) CONTENT DELIVERY NETWORK LOAD BALANCING

(71) Applicant: Fastly, Inc., San Francisco, CA (US)

(72) Inventor: Sean A. Leach, Castle Pines, CO (US)

(21) Appl. No.: 14/922,987

(22) Filed: Oct. 26, 2015

Related U.S. Application Data
(60) Provisional application No. 62/235,752, filed on Oct. 1, 2015.

(51) Int. Cl. H04L 29/08

(52) U.S. Cl. CPC H04L 67/1008; H04L 67/2847

(57) ABSTRACT

Requests for content cached by a content delivery network (CDN) are received by a content delivery network-wide (a.k.a., central) control node. This central control node distributes the requests to cache nodes to provide the requested content. The central control node serves as a centralized distribution point for content requests. The central control node may distribute requests based on the load at the point-of-presences (POPs) and/or the load on cache nodes regardless of their geographic location. Each point-of-presence may also have a control node to distribute requests sent to the point-of-presence. These POP control nodes distribute the requests received from a global control node to the cache nodes at that POP.

### RELATED APPLICATIONS

This application is related to and claims priority to U.S. Provisional Patent Application 62/235,752, titled “CONTENT DELIVERY NETWORK LOAD BALANCING,” filed Oct. 1, 2015, and which is hereby incorporated by reference in its entirety.

### TECHNICAL FIELD

Aspects of the disclosure are related to the field of packet communication networks and delivery of content from a source server to cache nodes.

### TECHNICAL BACKGROUND

Internet web pages, online information, and media content such as audio, video, photographs, and the like are requested and delivered to end users via computer network systems. Requests for the content are sent over the network to a source server, processed, and the content is delivered to the end user via the network. The source server can include origin or hosting servers which originally host the network content. Unfortunately, a single source server may not be able to serve a large number of concurrent requests for content. In addition, the requesting server may be distant geographically or network routing-wise from the source server. This can slow the process of delivering content to the point where users are dissatisfied, or abandon the request for content.

To address this problem, content delivery networks were developed. Content delivery networks cache content from a source server (a.k.a. origin server) for more rapid and reliable delivery to end users. A content delivery network may have many content nodes (up to thousands) distributed across a large geographic area (or network routing area) in order to provide faster, lower latency, and more reliable access to content for the end users, regardless of their geographic or network location.

The content delivery process typically begins with a user submitting a request to a browser. When a user enters a uniform resource locator (URL), a domain name system (DNS) request is triggered and an IP address is retrieved. In some content delivery network structures, the domain name of the URL is translated by a mapping system into the IP address of cache node, which can have the content cached locally, to serve the content to the user. If the content is cached by the cache node, the cache node can directly service the end user's request. If the content is not cached in the cache node, or the content from the origin server is out-of-date or stale, the cache node can receive the content from the origin server and cache it. Once cached, the cache node can typically provide the content quickly.

A cache node, however, may become overloaded. This can cause the content to be provided more slowly than is required or desired. Accordingly, one or more of the advantages and functions of a content delivery network can be disrupted by one or more overloaded cache nodes.

### Overview

In an embodiment, a method of operating a content delivery network, includes receiving, at a control node, content requests issued by end user devices for content cached at a plurality of points-of-presence (POPs). Each of the point-of-presences include a plurality of cache nodes to serve content requests. At the control node, a first content request issued by a first end user device for first content cached by the content delivery network is received. Based on load indicators associated with each POP, the control node selectes a first POP to provide delivery of the first content on behalf of a content provider associated with the first content.

In an embodiment, a content delivery network (CDN) includes a set of presence points. These presence points comprise a plurality of cache nodes (CN) at each presence point to provide content delivery on behalf of a set of participating content providers. The set of content providers source content for delivery by the CDN from at least one origin server. A control node receives content requests issued by end user devices for content cached by the CDN. The control node selects, from among the plurality of cache nodes, respective cache nodes to provide content delivery in response to the corresponding content requests.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the views. While multiple examples are described in connection with these drawings, the disclosure is not limited to the examples disclosed herein. On the contrary, the intent is to cover all alternatives, modifications, and equivalents.

FIG. 1 is a block diagram illustrating a content delivery network.

FIG. 2 is a flowchart illustrating the selection of cache nodes to provide requested content.

FIG. 3 illustrates an operational scenario for selecting a point-of-presence.

FIG. 4 illustrates an operational scenario for selecting a cache node.

FIG. 5 illustrates an operational scenario for global-local selection of a cache node.

FIG. 6 illustrates a cache node.

FIG. 7 illustrates a computer system.

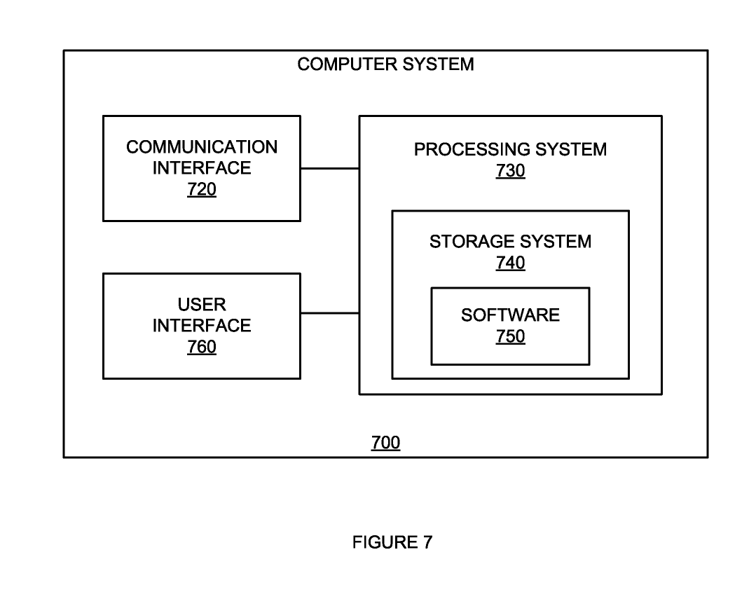

### DETAILED DESCRIPTION

In an embodiment, requests for content cached by a content delivery network (CDN) are received by a content delivery network-wide (a.k.a., central) control node. This central control node distributes the requests to cache nodes (CNs) to provide the requested content. The central control node serves as a centralized distribution point for content requests. The central control node may distribute requests based on the load at the point-of-presences (POPs) and/or the load on cache nodes regardless of their geographic location.

In an embodiment, each point-of-presence also has a control node to distribute requests sent to the point-of-presence. These POP control nodes distribute the requests received from a global control node to the cache nodes at that POP.

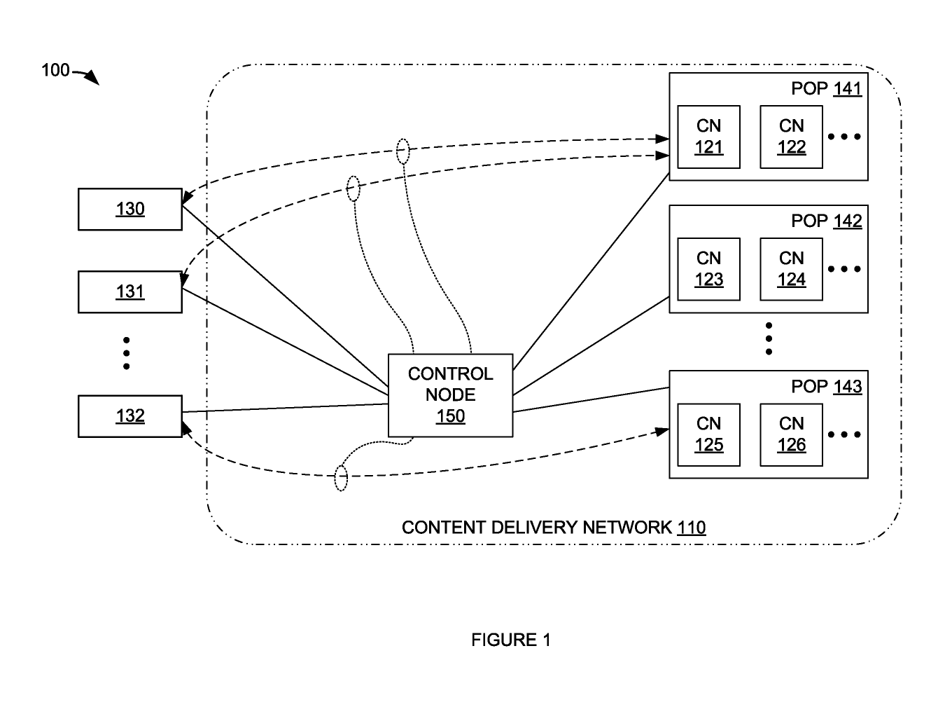

FIG. 1 is a block diagram illustrating a content delivery network. In FIG. 1, communication system 100 includes content delivery network 110, cache nodes 121-126, end user devices 130-132, points of presence (POPs) 141-143, and control node 150.

Each of cache nodes 121-126 can include one or more computer systems or servers. Each of cache nodes 121-126 can include one or more data storage systems. End user devices 130-132 are representative of a plurality of end user devices which can request and receive network content, and any number of end user devices 130-132 can be associated with each of cache nodes 121-126. Cache nodes 121-126 and end users 130-132 communicate over network links. Control node 150 and end users 130-132 communicate over network links. Control node 150 and POPs 141-143 communicate over network links. Control node 150 and cache nodes 121-126 communicate over network links. Although not shown in FIG. 1 for clarity, each of cache nodes 121-126 can also communicate with each other over one or more network links.

To further illustrate FIG. 1, a brief description of the operation of communication system 100 is included. In operation, end user devices 130-132 request network content, such as web pages, streaming video, streaming audio, etc. Instead of these requests being handled by the individual origin servers, individual cache nodes 121-126 of content delivery network 110 provide delivery of the content to the associated end user devices 130-132. Requested network content that is already stored in ones of cache nodes 121-126 can be provided quickly to the end user devices, while network content that is not already stored in ones of cache nodes 121-126 can be responsively requested by an associated one of cache nodes 121-126 from an appropriate origin server (not shown in FIG. 1) for delivery by the cache node 121-126 and possible caching by the cache nodes 121-126. In this manner, each of cache nodes 121-126 can act as intermediary proxy nodes to provide local and fast access for end user devices 130-132 to network content.

In an embodiment, control node 150, receives content requests issued by end user devices 130-132 for content cached at POPs 141-143. These content requests will be processed and served by a POP 141-143 and/or cache node 121-126 selected by control node 150. In other words, when a content request issued by an end user device (e.g., end user device 130) for content cached by the content delivery network 110 is received by control node 150, control node 150 selects a POP 141-142 to serve this request. This is illustrated in FIG. 1 by the bidirectional dashed lines from end user devices 130-132 and POPs 141-142 that are further shown being coupled to control node 150. In another embodiment, when a content request issued by an end user device (e.g., end user device 130) for content cached by the content delivery network 110 is received by control node 150, control node 150 selects a specific cache node 121-146 to serve this request.

POPs 141-143 and/or cache nodes 121-126 may provide control node 150 with load indicators. Alternatively, end user devices 130-132 can provide control node 150 with load indicators. These load indicators may correlate to a performance level that a particular POP 141-143 can provide content to an end user device 130-132. These load indicators may correspond to correlate to a performance level that a particular cache node 121-126 can provide content to an end user device 130-132.

In an embodiment, one or more of these load indicator may correspond a latency caused by the POP 141-143 and/or cache node 121-126—e.g., the time taken by a particular POP 141-143 and/or a particular cache node 121-126 to provide content in response to a content request issued by end user device 130-132. In an embodiment, one or more of these load indicator may correspond a latency caused by the network carrying the content and corresponding request(s) between the user device 130-132 and a particular POP 141-143 and/or a particular cache node 121-126. In an embodiment, one or more of these load indicator may correspond to a response time by the POP 141-143 and/or cache node 121-126—i.e., the time taken by a particular POP 141-143 and/or a particular cache node 121-126 to retrieve and supply content to the network in response to a content request issued by end user device 130-132. In an embodiment, one or more of these load indicator may correspond to a load being experienced by a particular POP 141-143 and/or a particular cache node 121-126—e.g., a number of clients presently served by a particular POP 141-143 and/or a particular cache node 121-126; the number of requests being serviced by a particular POP 141-143 and/or a particular cache node 121-126; and/or a data load on a particular POP 141-143 and/or a particular cache node 121-126 (e.g., media content vs. text/html content).

In an embodiment, one or more of these load indicator may correspond to a data subsystem loading/network subsystem loading of cache nodes 121-126, and/or the corresponding POP 141-143 itself. In an embodiment, one or more of these load indicators may correspond to wide-area network loading. In other words, a first POP 141-143 in a first network area (e.g., geographical area, routing region, backbone, etc.) with less network load may be able to respond with less latency than a second POP 141-143 that is associated with a different network area. In an embodiment, one or more of these load indicators may correspond to usage patterns. For example, at certain times of the day/week/etc., a POP 141-143 that is busy during business hours may perform with greater latency (i.e., slower) than a less busy POP 141-143--even though the less busy POP 141-143 is farther away (geographically or network-wise) from the user device 121-126.

In an embodiment, the load indicators may correspond to a particular POP 141-143 and/or a particular cache node 121-126 performance responding to certain types of content requests. In other words, a particular POP 141-143 and/or a particular cache node 121-126 may respond relatively better to video content requests than other POPs 141-143 and/or other cache nodes 121-126.

In an embodiment, based on one or more of these load indicators, control node 150 selects a POP 141-143 to provide delivery of the content. In another embodiment, based on the one or more of load indicators, control node 150 selects a cache node 121-126 to provide delivery of the content.

The load indicators associated with a particular POP 141-143 may be based on load indicators associated with the cache nodes 121-126 at that respective POP 141-143. In other words, one or more load indicators provided to control node 150 may be associated with, for example, POP 141. These load indicators may also be associated with a load on one or more of cache nodes 121-122 that are at POP 141. Accordingly, the load indicators associated with the load on one or more of cache nodes 121-122 may be used by control node 150 to select a particular one of cache nodes 121-122 to provide delivery of the selected content.

Cache nodes 121-126, POPs 141-142, cache nodes 121-126, and control node 150 can each include communication interfaces, network interfaces, processing systems, computer systems, microprocessors, storage systems, storage media, or some other processing devices or software systems, and can be distributed among multiple devices. Examples of cache nodes 121-126, POPs 141-142, cache nodes 121-126, and control node 150 can each include software such as an operating system, logs, databases, utilities, drivers, networking software, and other software stored on a computer-readable medium. Content delivery network 110, in addition to including cache nodes 121-126, can include equipment and links to route communications between cache nodes 121-126 and any of end user devices 130-132, POPs 141-142, and control node 150, among other operations.

End user devices 130-132 can each be a user device, subscriber equipment, customer equipment, access terminal, smartphone, personal digital assistant (PDA), computer, tablet computing device, e-book, Internet appliance, media player, game console, smartwatch, or some other user communication apparatus, including combinations thereof.

Communication links between elements of communication system 100 can each use metal, glass, optical, air, space, or some other material as the transport media. These communication links can each use various communication protocols, such as wireless communications, cellular communications, IEEE 802.11 (WiFi), Long Term Evolution (LTE), Time Division Multiplex (TDM), asynchronous transfer mode (ATM), Internet Protocol (IP), Ethernet, synchronous optical networking (SONET), hybrid fiber-coax (HFC), circuit-switched, communication signaling, or some other communication format, including combinations, improvements, or variations thereof. Communication links can each be a direct link or can include intermediate networks, systems, or devices, and can include a logical network link transported over multiple physical links. Although only one link for is shown in FIG. 1 between particular elements, it should be understood that this is merely illustrative to show communication modes or access pathways. In other examples, further links can exist, with portions of the further links shared and used for different communication sessions or different content types, among other configurations. Communication links can each include many different signals sharing the same associated link, as represented by the associated lines in FIG. 1, comprising resource blocks, access channels, paging channels, notification channels, forward links, reverse links, user communications, communication sessions, overhead communications, carrier frequencies, other channels, timeslots, spreading codes, transportation ports, logical transportation links, network sockets, packets, or communication directions.

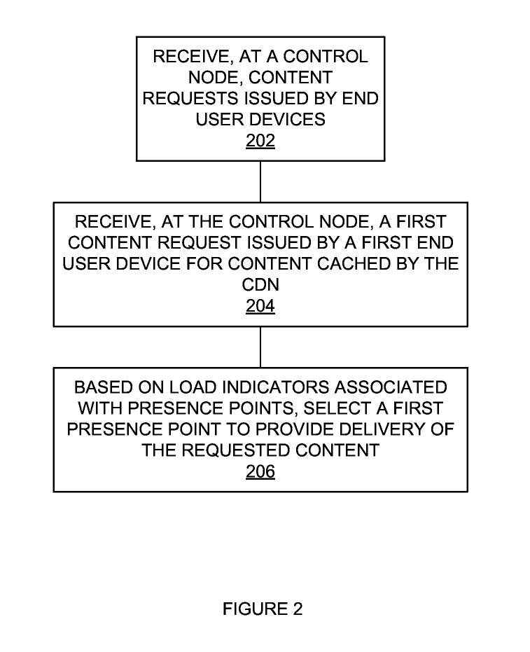

FIG. 2 is a flowchart illustrating the selection of cache nodes to provide requested content. The steps illustrated in FIG. 2 may be performed by one or more elements of communication system 100. At a control node, content requests issued by end user devices are received (202). For example, end user device 130-132 may make requests to control node 150 for content cached by CDN 110. Control node 150 may receive these requests from end user device 130-132 in order to assign a respective POP 141-143 to service each respective request.

At the control node, a first content request issued by a first end user device for content cached by the content delivery network is received (204). For example, control node 150 may receive a request from end user device 130 for content cached by CDN 110. Based on load indicators associated with presence point, a first presence point is selected to provide delivery of the requested content (206). For example, control node 150 may select POP 141 to provide delivery of the content requested by end user device 130. In an embodiment, after POP 141 is assigned to provide the requested content, POP 141 provides this content directly to end user device 130 without sending the content via control node 150—even though control node 150 is where the request from end user device 130 was initially routed.

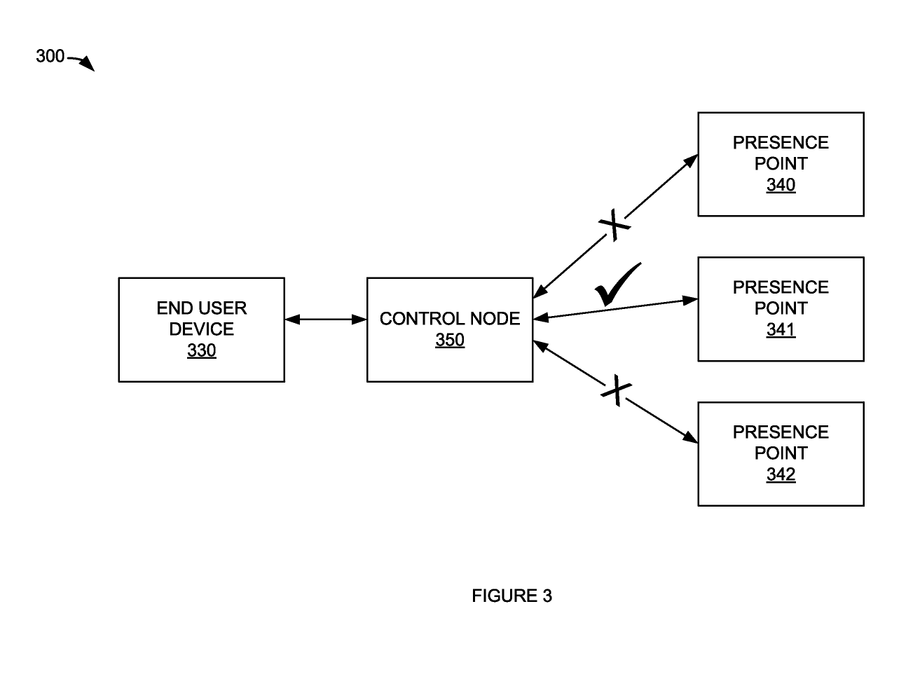

FIG. 3 illustrates an operational scenario for selecting a point-of-presence. In FIG. 3, communication system 300 is shown as including an end user device 330, a control node 350, POP 340, POP 341, and POP 342. End user device 330 is operatively coupled to control node 350. End user device 330 is operatively coupled to control node 350 to make a request for content. Control node 350 is operatively coupled to POP 340, POP 341, and POP 342. Control node 350 is operatively coupled to POP 340, POP 341, and POP 342 in order to select one of POP 340, POP 341, and POP 342 to service the request for content by end user device 330. Control node 350 may be operatively coupled to POPs 340-342 in order to receive load indicators from POPs 340-342 that are associated with an expected performance level of a respective POP 340-342 when responding to a request for content by the end user device 330. Alternatively, end user device 330 can provide control node 350 with load indicators.

In an embodiment, one or more of these load indicator may correspond a latency caused by the POP 340-342. In an embodiment, one or more of these load indicator may correspond a latency caused by the network carrying the content and corresponding request(s) between the user device 330 and a particular POP 340-342. In an embodiment, one or more of these load indicator may correspond to a response time by the POP 340-342. In an embodiment, one or more of these load indicator may correspond to a load being experienced by a particular POP 340-342—e.g., a number of clients presently served by a particular POP 340-342; the number of requests being serviced by a particular POP 340-342; and/or a data load on a particular POP 340-342 (e.g., and amount of media content vs. text/html content).

In an embodiment, one or more of these load indicator may correspond to a data subsystem loading/network subsystem loading of cache nodes within a POP 340-342, and/or the corresponding POP 340-342 itself. In an embodiment, one or more of these load indicators may correspond to wide-area network loading. In other words, a first POP 340-342 in a first network area (e.g., geographical area, routing region, backbone, etc.) with less network load may be able to respond with less latency than a second POP 340-342 that is associated with a different network area. In an embodiment, one or more of these load indicators may correspond to usage patterns. For example, at certain times of the day/week/etc., a POP 340-342 that is busy during business hours may perform with greater latency (i.e., slower) than a less busy POP 340-342—even though the less busy POP is farther away (geographically or network-wise) from the end user device 330.

In an embodiment, the load indicators may correspond to a particular POP 340-342′s performance responding to certain types of content requests. In other words, a particular POP 340-342 may respond relatively better to video content requests than other POPs 340-342.

Control node 350 selects, from among POPs 340-342, POP 341 to provide the requested content to end user device 330. This is illustrated in FIG. 3 by the checkmark (meaning ‘selected’) next to the link between control node 350 and POP 341, and the ‘X’s (meaning ‘not selected’) cutting the links between control node 350 and POPs 340 and 343.

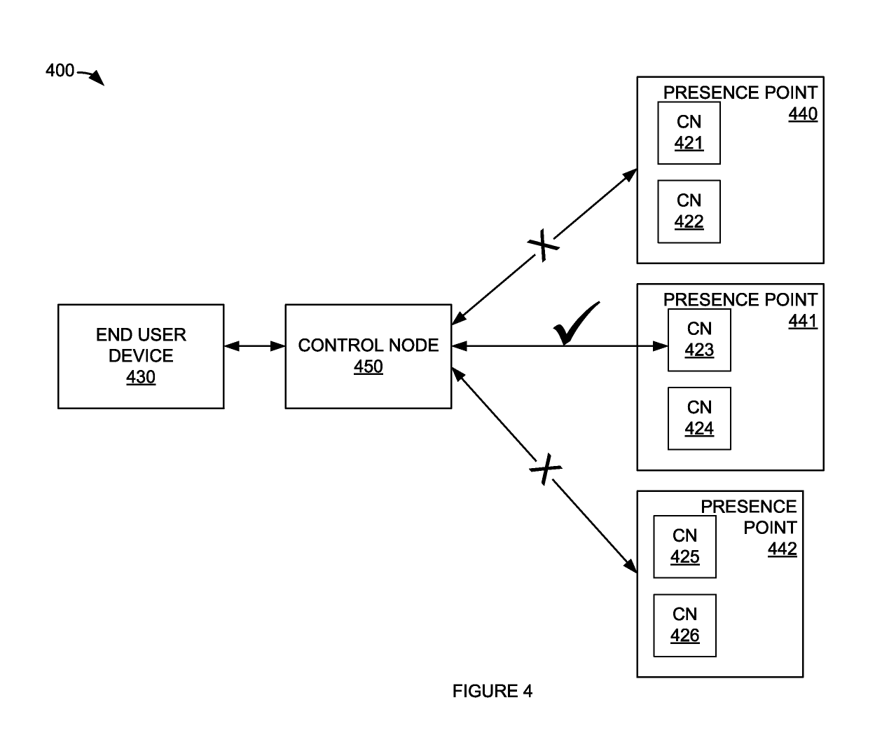

FIG. 4 illustrates an operational scenario for selecting a cache node. In FIG. 4, communication system 400 is shown as including an end user device 430, a control node 450, POP 440, POP 441, and POP 442. POP 440 include cache node 421 and cache node 422. POP 441 include cache node 423 and cache node 424. POP 442 include cache node 425 and cache node 425.

End user device 430 is operatively coupled to control node 450. End user device 430 is operatively coupled to control node 350 to make a request for content. Control node 450 is operatively coupled to POP 440, POP 441, and POP 442. Control node 450 is operatively coupled to POP 440, POP 441, and POP 442 in order to select one of cache node 421-426 to service the request for content by end user device 430. Control node 450 may be operatively coupled to POPs 440-442 in order to receive load indicators from cache nodes 421-426 that are associated with the ability of a cache nodes 421-426 to quickly provide the content requested by end user device 430.

Control node 450 selects, from cache nodes 421-426, cache node 423 in POP 441 to provide the requested content to end user device 430. This is illustrated in FIG. 4 by the checkmark (meaning ‘selected’) next to the link between control node 450 and cache node 423, and the ‘X’s (meaning ‘not selected’) cutting the links between control node 450 and POPs 440 and 443.

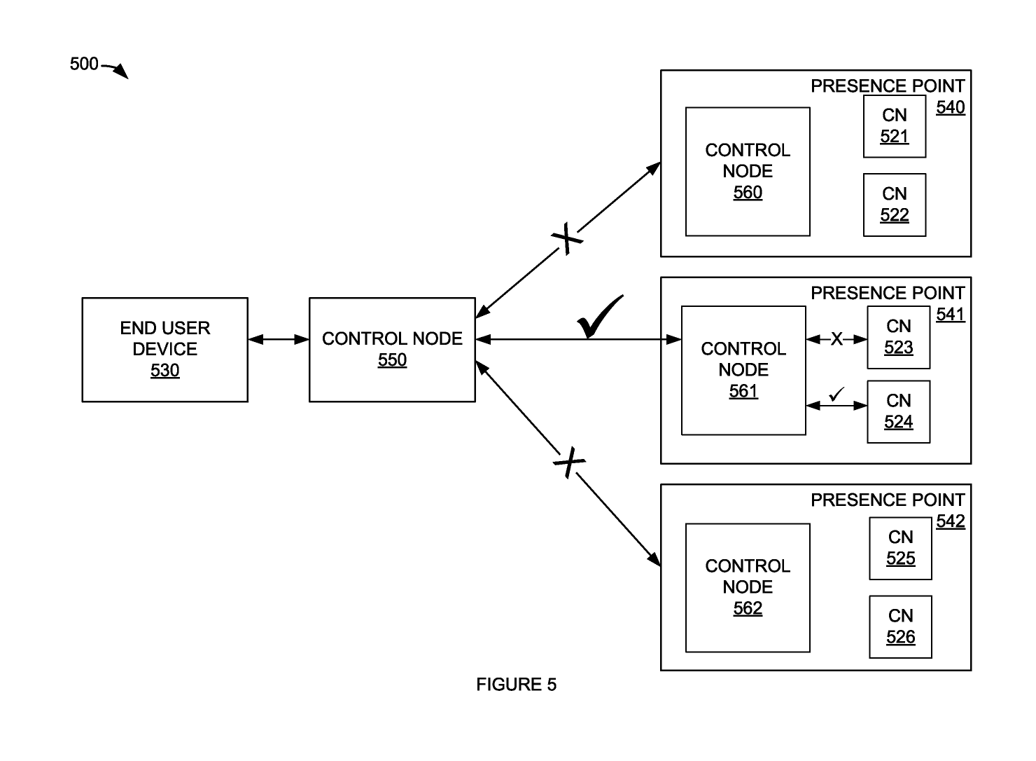

FIG. 5 illustrates an operational scenario for global-local selection of a cache node. In FIG. 5, communication system 500 is shown as including an end user device 530, a control node 550, POP 540, POP 541, and POP 542. POP 540 includes cache node 521, cache node 522, and control node 560. POP 541 includes cache node 523, cache node 524, and control node 561. POP 542 includes cache node 525, cache node 526, and control node 562.

End user device 530 is operatively coupled to control node 550. End user device 530 is operatively coupled to control node 550 to make a request for content. Control node 550 is operatively coupled to POP 540, POP 541, and POP 542. Control node 550 is operatively coupled to POP 540, POP 541, and POP 542 in order to select one of POP 540, POP 541, and POP 542 to service the request for content by end user device 530. Control node 550 may be operatively coupled to POPs 540-542 in order to receive load indicators from POPs 540-542 that are associated with the ability of a POP 540-542 to quickly provide the content requested by end user device 530. Alternatively, end user device 530 can provide control node 550 with load indicators.

In FIG. 5, control node 550 is illustrated selecting, from POPs 540-542, POP 541 to provide the requested content to end user device 530. This is illustrated in FIG. 5 by the checkmark (meaning ‘selected’) next to the link between control node 550 and POP 541, and the ‘X’s (meaning ‘not selected’) cutting the links between control node 550 and POPs 540 and 543. Once control node 550 has selected POP 541, control node 561 at POP 541 is illustrated selecting, from cache nodes 523-524, cache node 524 to provide the requested content to end user device 530. This is illustrated in FIG. 5 by the checkmark (meaning ‘selected’) next to the link between control node 561 and cache node 524, and the ‘X’ (meaning ‘not selected’) cutting the link between control node 561 and cache node 523.

In an embodiment, a control node 561 may reject the request to provide the requested content. In this case, control node 561 would send a message to control node 561 indicating that POP 541 will not be providing the requested content. Control node 550 may then select a different POP (e.g., POP 540 or POP 542) to provide the requested content.

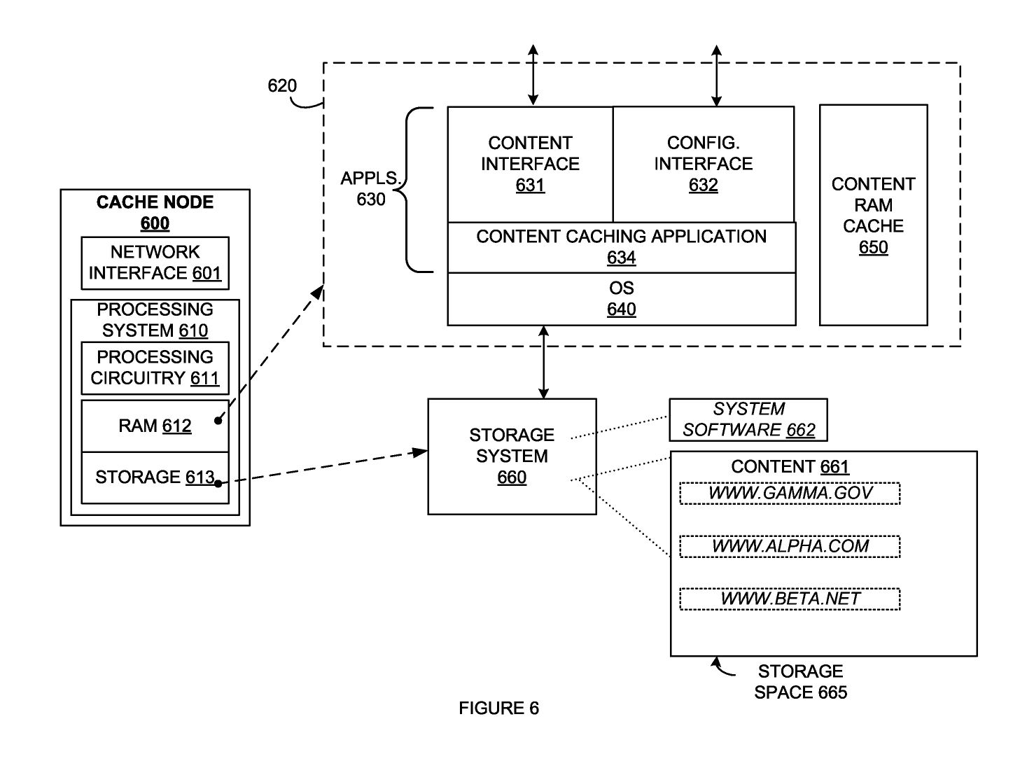

To further describe the equipment and operation of a cache node, FIG. 6 is provided which illustrates cache node 600. Cache node 600 can be an example of cache nodes 121-126 of FIG. 1, cache nodes in presence points 340-341 of FIG. 3, cache node 421-426 of FIG. 4, and cache nodes 521-526 of FIG. 5, although variations are possible. Cache node 600 includes network interface 601 and processing system 610. Processing system 610 includes processing circuitry 611, random access memory (RAM) 612, and storage 613, although further elements can be included, such as discussed in FIGS. 1, and 3-5. Example contents of RAM 612 are further detailed in RAM space 620, and example contents of storage 613 are further detailed in storage system 660.

Processing circuitry 611 can be implemented within a single processing device but can also be distributed across multiple processing devices or sub-systems that cooperate in executing program instructions. Examples of processing circuitry 611 include general purpose central processing units, microprocessors, application specific processors, and logic devices, as well as any other type of processing device. In some examples, processing circuitry 611 includes physically distributed processing devices, such as cloud computing systems.

Network interface 601 includes one or more network interfaces for communicating over communication networks, such as packet networks, the Internet, and the like. The network interfaces can include one or more local or wide area network communication interfaces which can communicate over Ethernet or Internet protocol (IP) links. Network interface 601 can include network interfaces configured to communicate using one or more network addresses, which can be associated with different network links. Examples of network interface 601 include network interface card equipment, transceivers, modems, and other communication circuitry.

RAM 612 and storage 613 together can comprise a non-transitory data storage system, although variations are possible. RAM 612 and storage 613 can each comprise any storage media readable by processing circuitry 611 and capable of storing software. RAM 612 can include volatile and nonvolatile, removable and non-removable media implemented in any method or technology for storage of information, such as computer readable instructions, data structures, program modules, or other data. Storage 613 can include non-volatile storage media, such as solid state storage media, flash memory, phase change memory, magnetic memory, or as illustrated by storage system 460 in this example. RAM 612 and storage 613 can each be implemented as a single storage device but can also be implemented across multiple storage devices or sub-systems. RAM 612 and storage 613 can each comprise additional elements, such as controllers, capable of communicating with processing circuitry 611.

Software stored on or in RAM 612 or storage 613 can comprise computer program instructions, firmware, or some other form of machine-readable processing instructions having processes that when executed a processing system direct cache node 600 to operate as described herein. For example, software drives cache node 600 to receive requests for content, determine if the content is stored in cache node 600, retrieve content from origin servers, transfer content to end user devices, manage data storage systems for handling and storing the content, among other operations. The software can also include user software applications. The software can be implemented as a single application or as multiple applications. In general, the software can, when loaded into a processing system and executed, transform the processing system from a general-purpose device into a special-purpose device customized as described herein.

RAM space 620 illustrates a detailed view of an example configuration of RAM 612. It should be understood that different configurations are possible. RAM space 620 includes applications 630, operating system (OS) 640, and content RAM cache 650. Content RAM cache 650 includes RAM space for temporary storage of content, such as dynamic random access memory (DRAM).

Applications 630 include content interface 631, configuration interface 632, and content caching application 634. Content caching application 634 handles caching of content and management of storage spaces, such as content RAM cache 650 and storage space 665, as well as exchanges content, data, and instructions via content interface 631, and configuration interface 632. Content caching application 634 can comprise a custom application, Varnish caching software, hypertext transfer protocol (HTTP) accelerator software, or other content caching and storage applications, including variation, modifications, and improvements thereof. Applications 630 and OS 640 can reside in RAM space 620 during execution and operation of cache node 600, and can reside in system software storage space 662 on storage system 660 during a powered-off state, among other locations and states. Applications 630 and OS 640 can be loaded into RAM space 620 during a startup or boot procedure as described for computer operating systems and applications.

Content interface 631 and configuration interface 632 each allow a user to interact with and exchange data with content caching application 634. In some examples, each of content interface 631 and configuration interface 632 comprise an application programming interface (API). Content interface 631 allows for exchanging content for caching in cache node 600 by content caching application 634, and can also receive instructions to purge or erase data from cache node 600. Content interface 631 can retrieve tracking elements as well as network and web page content from origin servers for delivery to end users. Configuration interface 632 allows for altering the configuration of various operational features of content caching application 634. In some examples, configuration interface 632 comprises a scripting language interface, such as Varnish Configuration Language (VCL), Perl, PHP, Javascript, or other scripting or interpreted language-based interfaces. Content interface 631 and configuration interface 632 can each communicate with external systems via network interface 601 over any associated network links.

Storage system 660 illustrates a detailed view of an example configuration of storage 613. Storage system 660 can comprise flash memory such as NAND flash or NOR flash memory, phase change memory, magnetic memory, among other solid state storage technologies. As shown in FIG. 6, storage system 660 includes system software 662, as well as content 661 stored in storage space 665. As described above, system software 662 can be a non-volatile storage space for applications 630 and OS 640 during a powered-down state of cache node 600, among other operating software. Content 661 includes cached content, such as the web content examples in FIG. 1, which can include text, data, pictures, video, audio, web pages, scripting, code, dynamic content, or other network content. Content 661 can also include tracking elements, such as transparent GIFs, web bugs, Javascript tracking elements, among other tracking elements. In this example, content 661 includes network content and web pages associated with one or more websites, as indicated by www.gamma.gov, www.alpha.com, and www.beta.net.

Cache node 600 is generally intended to represent a computing system with which at least software 630 and 640 are deployed and executed in order to render or otherwise implement the operations described herein. However, cache node 600 can also represent any computing system on which at least software 630 and 640 can be staged and from where software 630 and 640 can be distributed, transported, downloaded, or otherwise provided to yet another computing system for deployment and execution, or yet additional distribution.

The methods, systems, devices, networks, databases, wireless stations, and base stations described above may be implemented with, contain, or be executed by one or more computer systems. The methods described above may also be stored on a computer readable medium. Many of the elements of system 100, system 300, system 400, system 500, content delivery network 110, cache nodes 121-126, end user devices 130-132, points of presence (POPs) 141-143, control node 150, end user device 330, control node 350, POPs 340-342, end user device 430, control node 450, POPs 440-442, cache nodes 421-426, end user device 530, control node 550, POPs 540-542, control nodes 560-561, and cache nodes 521-526 may be, comprise, or include computer systems.

FIG. 6 illustrates a block diagram of a computer system. Computer system 600 includes communication interface 620, processing system 630, and user interface 660. Processing system 630 includes storage system 640. Storage system 640 stores software 650. Processing system 630 is linked to communication interface 620 and user interface 660. Computer system 600 could be comprised of a programmed general-purpose computer, although those skilled in the art will appreciate that programmable or special purpose circuitry and equipment may be used. Computer system 600 may be distributed among multiple devices that together comprise elements 620-660.

Communication interface 620 could comprise a network interface, modem, port, transceiver, or some other communication device. Communication interface 620 may be distributed among multiple communication devices. Processing system 630 could comprise a computer microprocessor, logic circuit, or some other processing device. Processing system 630 may be distributed among multiple processing devices. User interface 660 could comprise a keyboard, mouse, voice recognition interface, microphone and speakers, graphical display, touch screen, or some other type of user device. User interface 660 may be distributed among multiple user devices. Storage system 640 may comprise a disk, tape, integrated circuit, server, or some other memory device. Storage system 640 may be distributed among multiple memory devices.

Processing system 630 retrieves and executes software 650 from storage system 640. Software 650 may comprise an operating system, utilities, drivers, networking software, and other software typically loaded onto a computer system. Software 650 may comprise an application program, firmware, or some other form of machine-readable processing instructions. When executed by processing system 630, software 650 directs processing system 630 to operate as described herein.

The included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the invention. Those skilled in the art will also appreciate that the features described above can be combined in various ways to form multiple embodiments. As a result, the invention is not limited to the specific embodiments described above, but only by the claims and their equivalents.

What is claimed is:

1. A method of operating a content delivery network, comprising:
receiving, at a control node, content requests issued by end user devices for content cached at a plurality of points-of-presence (POPs), each point-of-presence including a plurality of cache nodes to serve content requests;
receiving, at the control node, a first content request issued by a first end user device for first content cached by the content delivery network; and,
based on load indicators associated with each POP, selecting, by the control node, a first POP to provide delivery of the first content on behalf of a content provider associated with the first content.

2. The method of claim 1, further comprising:
receiving the load indicators associated with each POP transferred from each POP.

3. The method of claim 1, further comprising:
receiving the load indicators associated with one or more of the POPs transferred by one or more of the end user devices.

4. The method of claim 1, wherein the control node selects the first POP to provide delivery of the first content based on the load indicators associated with a plurality of servers at each POP.

5. The method of claim 1, further comprising:
based on load indicators associated with a plurality of cache nodes at the first POP selecting, a first cache node from the plurality of cache nodes at the first POP to provide delivery of the first content on behalf of the content provider.

6. The method of claim 5, wherein the load indicators associated with each POP from each POP include cache node load indicators associated with each cache node at a POP.

7. The method of claim 5, wherein the selecting of the first cache node is performed by a first control node at the first POP.

8. A content delivery network (CDN), comprising:
a set of presence points comprising a plurality of cache nodes at each presence point to provide content delivery on behalf of a set of participating content providers, at least one of the set of content providers sourcing content for delivery by the CDN from an origin server; and,
a control node to receive content requests issued by end user devices for content cached by the CDN, the control node to select based on at least loading indicators of the plurality of cache nodes, from among the plurality of cache nodes to provide content delivery in response to the corresponding content requests.

9. The content delivery network of claim 8, wherein the control node selects a presence point to provide the respective cache nodes.

10. The content delivery network of claim 9, wherein a presence point control node selects a respective cache node from the respective cache nodes at the presence point.

11. The content delivery network of claim 9, wherein the control node selects a respective cache node from the respective cache nodes at the presence point.

12. The content delivery network of claim 8, wherein the control node receives the load indicators transferred by ones of the end user devices, and the control node uses the load indicators to select the presence point to provide the respective cache nodes.

13. The content delivery network of claim 8, wherein the control node receives the load indicators from the set of presence points, and the control node uses the load indicators to select the presence point to provide the respective cache nodes.

14. The content delivery network of claim 8, wherein the control node receives the load indicators from respective cache nodes, and the control node uses the load indicators to select the presence point to provide the respective cache nodes.

15. The content delivery network of claim 8, wherein the control node receives the load indicators from respective cache nodes, and the control node uses the load indicators to select a cache node from the respective cache nodes to provide content delivery in response to the corresponding content requests.

16. A computer apparatus to operate a content delivery network, the computer apparatus comprising:
processing instructions that direct a control node, when executed by the control node, to:
receive, at a control node, content requests issued by end user devices for content cached at a plurality of points-of-presence (POPs), each point-of-presence including a plurality of cache nodes to serve content requests;
receive, at the control node, a first content request issued by a first end user device for first content cached by the content delivery network; and,
based on at least load indicators associated with each POP, select, by the control node, a first POP to provide delivery of the first content on behalf of a content provider associated with the first content.

17. The computer apparatus of claim 16, wherein the control node is further directed to:
based on load indicators associated with a plurality of servers at the first POP select, a first server from the plurality of servers at the first POP to provide delivery of the first content on behalf of the content provider.

18. The computer apparatus of claim 16, wherein the control node is further directed to:
receive the load indicators associated with each POP from ones of the POPs or ones of the end user devices.

19. The computer apparatus of claim 16, wherein the control node selects the first POP to provide delivery of the first content based on load indicators associated with a plurality of servers at each POP.

20. The computer apparatus of claim 16, wherein the control node selects the first POP to provide delivery of the first content by selecting a first server located at the first POP to provide delivery of the first content.
